(19) United States
(12) Patent Application Publication
(10) Pub. No.: US 2017/0130180 A1
(43) Pub. Date: May 11, 2017

(54) METHOD OF CLEANING BEER AND BEER CLEANING APPARATUS

(71) Applicant: Simon H. Steiner, Hopfen, GmbH, Mainburg (DE)

(72) Inventor: Wilhelm Mitter, Mainburg (DE)

(21) Appl. No.: 15/337,386

(22) Filed: Oct. 28, 2016

(30) Foreign Application Priority Data
Nov. 5, 2015 (EP) 15 003 168.0

(51) Int. Cl. C12H 1/07; B01D 29/64; B01D 35/02; B01D 35/147

(52) U.S. Cl. CPC C12H 1/063; B01D 35/147; B01D 29/6438; B01D 35/02; B01D 2201/282

(57) ABSTRACT

The present invention relates to a method of cleaning or filtering beer, having the following steps:
applying beer onto an obliquely positioned filter (10), so that the beer runs down along the obliquely positioned filter (10) and liquid contained therein passes through openings of the filter (10) into a collecting space (20) beneath the filter (10) and solids contained in the beer slide downwards along the obliquely positioned filter (10), and
routing the filtered beer out of the collecting space (20).

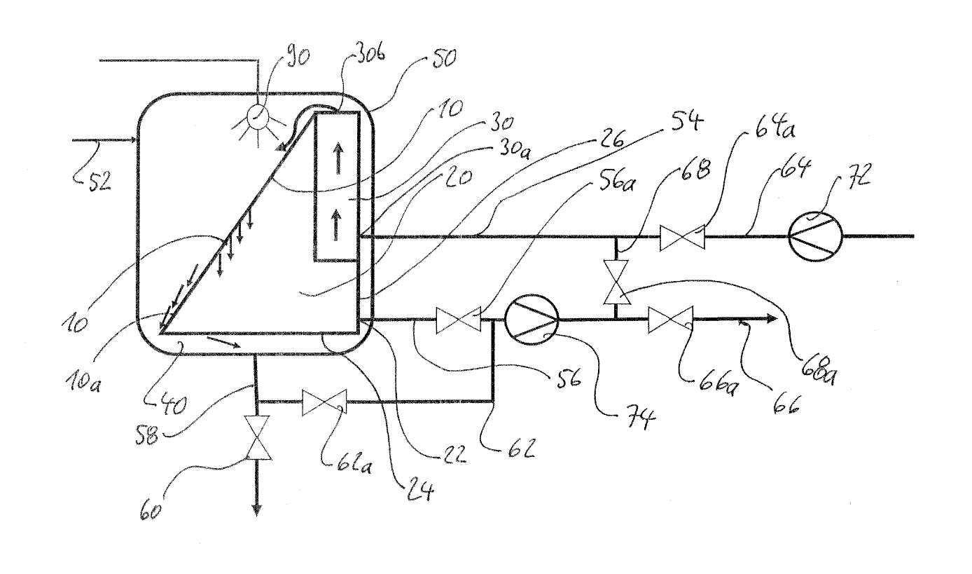

The invention also relates to a beer cleaning apparatus.

This application claims priority to and the benefit of EP Application No. 15 003 168.0 filed on Nov. 5, 2015, which is incorporated by reference herein in their entirety.

The present invention relates to a method of cleaning beer and to a corresponding apparatus.

In recent years, an old hopping method known as cold hopping or, more particularly, dry hopping, has become popular again. In addition to the hops being used for brewing, hops in the form of cone hops or pellets are also used to impart aroma during fermentation and/or storage.

In this method, it is necessary in the end for the solids stemming from hopping and also other particles to be removed from the beer again. This is done usually, for example, using a beer filter, as is described in WO 02/074411 A1. This beer filter has a multiplicity of filter candles, which periodically have to be cleaned of the solids which are kept back. The more a beer filter clogs up, the lower is the throughput and the greater is the level of energy required for flushing through the filter.

Consideration has therefore already been given to cleaning beer using a different method. An alternative method would be to use a centrifuge, in which solids settle as a result of the centrifugal force. A centrifuge, however, requires large amounts of energy, and therefore this idea was pursued only to some extent.

Use is conventionally also made of pre-dissolved hop pellets, which settle on the base of a container. However, this gives rise to large amounts of beer being lost in the waste which is separated off.

It is therefore an object of the invention to create an improved cleaning method which is intended for removing the solids from beer and by means of which it is possible to clean beer efficiently and maximize an output of cleaned beer. The intention is also to provide a corresponding beer cleaning apparatus.

This object is achieved by the features of the independent claims. Advantageous developments are defined in the dependent claims.

According to one aspect, the invention provides a method of cleaning or filtering beer, having the following steps: applying beer to an obliquely positioned filter or screen, so that the beer runs down along the obliquely positioned filter. The filter is preferably of plate-like design or in the form of an essentially planar plate. Liquid contained in the beer which is to be cleaned passes through openings of the filter into a collecting space beneath the filter and solids contained in the beer slide downwards along the obliquely positioned filter. The filtered beer is routed out of the collecting space.

Positioning the filter, in particular a plate-like rectilinear filter, obliquely makes it possible for the solids contained in the beer which is to be cleaned to slide down along the surface of the filter and therefore for the filter openings not to clog up or close. In other words, the throughput of the filter remains essentially constant throughout its operation because the openings of the filter are not blocked up by solids.

The filter or the screen thus acts in accordance with the principle of a slanting plane, in the case of which the solids slide downwards on account of the downhill force, in order to be separated off from the liquid. In contrast, the liquid passes through the openings or slits or through-passages of the filter and into the collecting space provided beneath the filter, in order for the cleaned or filtered beer to be collected there.

The term “slanting plane”, however, must not be understood to mean that the filter or the screen has to be of planar design. The filter or screen may also be of other configurations, for example in curved, undulating, stepped or similar form, as long as it is possible to generate a sufficient downhill force for separating off the solids.

The method also preferably comprises the steps of accumulating the solids in an accumulating space beneath the filter and periodically or continuously removing the solids from the accumulating space.

The step of applying the beer to the filter also preferably includes the step of arranging an overflow vessel in the upper region of the filter, in order to allow beer which exits from the overflow vessel to flow onto the filter. The action of the beer running out of the overflow vessel onto the filter gives rise to a uniform, essentially laminar, flow of the beer along the obliquely positioned filter, so that a maximum quantity of liquid can pass through the openings of the filter and an optimum level of solids can thus be separated off. This therefore gives a maximum yield of the filtered beer.

Since the beer is further preferably subjected to pressure by way of carbon dioxide during filtering, on the one hand the carbon-dioxide content of the beer is maintained and on the other hand there is a difference in pressure generated between an upstream side of the filter and a downstream side of the filter or the collecting space, so that the filter is prevented from being blocked up. In other words, the pressure on an entry side of the filter is greater than that on an exit side of the filter, and the fluid is therefore forced through the openings of the filter.

The method preferably also has the step of periodically cleaning the filter by spraying the same with a cleaning fluid.

The filter is also preferably positioned obliquely through approximately 10° to approximately 80°, preferably through approximately 30° to approximately 60°, in relation to the horizontal.

According to a further aspect, the invention provides a beer cleaning apparatus having an obliquely positioned filter and a collecting space, which is arranged beneath the filter, an overflow vessel with an inlet for the introduction of beer and with an overflow for applying the overflowing beer to the filter, and an outlet. The outlet is connected to the collecting space with the purpose of channeling away the cleaned beer.

The beer cleaning apparatus also preferably has an accumulating space beneath the filter for accumulating the solids separated off from the beer, wherein the accumulating space is preferably connected to a slide in order to open and close the accumulating space selectively for the purpose of removing the solids.

The filter of the beer cleaning apparatus is also preferably positioned obliquely through approximately 10° to approximately 80°, preferably through approximately 30° to approximately 60°, in relation to the horizontal, so that the solids slide down the slope and the openings of the filter cannot be blocked up.

The beer cleaning apparatus also preferably comprises a pressure tank, in which the filter and the collecting space are arranged and which can be connected to a gas source, in particular to a gas source containing carbon dioxide, so that the beer can be subjected to pressure by way of gas during cleaning or during filtering.

The pressure tank also preferably has at least one spray nozzle, which can be connected to a container provided with cleaning agent in order to clean the interior of the pressure tank and/or the filter.

It is also preferable for a bypass with a bypass valve to be arranged between the inlet of the overflow vessel and the outlet of the collecting space and/or for a return line to be arranged between a discharge point, which is connected to the accumulating space, and the outlet of the collecting space, the return line having a return valve in order for the return line to be opened or closed selectively.

Beer which has already been filtered can be fed once again to the inlet, through the bypass, in order for filtering to be carried out again. In the initial phase of the beer cleaning apparatus, liquid contained in the separated-off solids can be fed back into circulation by way of the return line for the purposes of cleaning in order for an output quantity of cleaned beer to be increased. In other words, liquid contained in the separated-off solids can be fed to the inlet of the beer cleaning apparatus, via the return line, in order for the liquid to be filtered anew and not to be separated off with the solids.

A respective pump, preferably an electrically driven pump, is preferably arranged in an infeed to the inlet of the overflow vessel and/or in a removal line for channeling away cleaned beer from the outlet of the collecting space.

The filter preferably has slit-like openings with a slit width of approximately 100 to approximately 500 μm, preferably with a slit width of approximately 200 to approximately 300 μm.

The invention will now be explained in more detail by way of an exemplary embodiment and with reference to the single FIGURE.

The FIGURE shows a beer cleaning apparatus which is arranged in a pressure tank and has a collecting space and an accumulating space for accumulating the solids.

As is shown in the FIGURE, an obliquely positioned, plate-like filter 10 is arranged above a collecting space 20. The filter 10 has a multiplicity of openings (not shown), through which the separated-off liquid can pass. These openings are designed, for example, in the form of slits with a slit width of approximately 100 to approximately 500 μm, preferably with a slit width of approximately 200 to approximately 300 μm.

The collecting space 20 is formed or bounded by the filter 10 and a container base 24 and also a circumferential container wall 26. An upper side of the collecting space 20 also has arranged on it an overflow vessel 30 which, on its upper side, has an overflow 30b and, on its underside, has an inlet 30a for the introduction of beer which is to be cleaned.

The liquid introduced into the inlet 30a rises up in the overflow vessel 30 until it reaches the overflow 30b, and it then exits from the overflow 30b. The beer exiting from the overflow 30b runs down the obliquely positioned filter 10, wherein the liquid passes through the filter 10, via the openings arranged in the filter 10, and runs into the collecting space 20.

The liquid collected in the collecting space 20 can be let out of the collecting space 20 via the outlet 22. Solids contained in the beer which is to be cleaned slide down along the obliquely positioned filter 10 without passing through the openings of the filter 10. Accordingly, the solids drop down on the underside 10a of the filter 10 and are accumulated in an accumulating space 40 beneath the filter 10. In order to remove solids accumulated in the accumulating space 40, the accumulating space 40 is provided, on its base, with a discharge point 58, which can be opened and closed by a slide 60. When the slide 60 is opened, the separated-off solids can be removed from the accumulating space 40.

For the feed of beer which is to be cleaned, a feed line 54 is connected to an infeed 64, which can be opened and closed by a feed valve 64a. For the purpose of delivering the beer which is to be cleaned, preferably a feed pump 72 is arranged in the infeed 64. This feed pump 72 is preferably an electrically driven delivery pump.

Furthermore, the outlet 22 of the collecting space 20 is provided with a removal line 56, which can be opened and closed by a removal-line valve 56a. It is also preferred for the removal line 56 to be provided with a removal-line pump 74, which, like the feed pump 72, is preferably an electric delivery pump. An outlet of the removal-line pump 74 is connected to an exit 66 for the cleaned beer. Furthermore, the exit 66 is provided with an outlet valve 66a, which can be opened and closed.

Furthermore, the discharge point 58 is preferably provided with a return line 62, which is connected at a downstream end to the removal line 56. Liquid contained in the separated-off solids can be routed back through said return line 62, which is provided with a return valve 62a for opening and closing the return line 62.

Finally, the removal line 56 can be connected to the feed line 54 via a bypass 68, by virtue of a bypass valve 68a arranged in the bypass 68 being opened. This allows fluid or liquid to be routed back out of the removal line 56, via the bypass 68 and the open bypass valve 68a, into the feed line 54, in order for the fluid or the liquid to be cleaned or filtered anew.

The operation of the beer cleaning apparatus and the method of cleaning the beer will be described hereinbelow. Normal operation of the beer cleaning apparatus will be described in the first instance.

During normal operation, the feed pump 72 is switched on, in order for beer which is to be cleaned to be delivered, via the infeed 64 and the open feed valve 64a, to the inlet 30a of the overflow vessel 30. The beer which is to cleaned rises up correspondingly in the overflow vessel 30 until it reaches the overflow 30b. As the beer which is to be cleaned continues to be delivered, the beer runs out of the overflow 30b of the overflow vessel 30 and flows downwards along the obliquely positioned filter 10.

The liquid contained in the beer which is to be cleaned can flow through the openings of the filter 10, in order to drip into the collecting space 20 or enter into the collecting space 20. In contrast, solids contained in the beer which is to be cleaned, rather than being able to pass through the openings of the filter 10, slide downwards along the obliquely positioned filter 10, in order to pass into the accumulating space 40. During normal operation, the slide 60 is closed, and the separated-off solids therefore accumulate in the accumulating space 40. The solids can be removed from the accumulating space 40 by virtue of the slide 60 being opened periodically.

The liquid collected in the collecting space 20 can flow to the removal-line pump 74 via the outlet 22, with the removal-line valve 56a open, along the removal line 56 in order to reach the exit 66 via the opened outlet valve 66a. The cleaned beer is thus let out at the exit 66. During this normal operation, both the bypass valve 68a and the return valve 62a are closed.

For the purpose of separating off the solids out of the accumulating space 40, the slide 60 can be opened at periodic intervals, in order for the separated-off solids to be removed from the accumulating space 40 via the discharge point 58.

In the initial phase of the beer cleaning apparatus, the throughput of the beer which is to be cleaned has to be set in the first instance so that a maximum quantity of liquid passes through the openings of the filter 10 rather than into the accumulating space 40. In other words, the throughput has to be set such that a maximum quantity of liquid can pass through the filter 10 before the liquid reaches a lower end, or the underside 10a, of the filter 10 and passes into the accumulating space 40.

The return line 62 and the bypass 68 are provided so that in the case of excessive throughput, during which liquid passes into the accumulating space 40, said liquid can be brought back into circulation. In this case, the return valve 62a and the bypass valve 68a are opened and the outlet valve 66a is closed, in order for liquid to be routed back to the feed line 54 from the accumulating space 40, via the return line 62 and the bypass 68. The liquid can thus be brought back into circulation from the accumulating space 40, in order for said liquid to be fed into the inlet 30a of the overflow vessel 30 and cleaned or filtered anew. During normal operation, the bypass valve 68a and the return valve 62a are then closed, as has already been mentioned.

Furthermore, an upper side or upstream side of the filter 10 is subjected to pressure by way of carbon dioxide, by way of the filter 10 being arranged with the overflow vessel 30 and the collecting space 20 within a pressure tank 50. This pressure tank 50 has a pressure connection 52, via which carbon dioxide (CO₂) is fed under pressure to the pressure tank 50. The CO₂ pressure here is set to approximately 0.6 to 0.8 bar, but at most 0.99 bar.

In order for the filter 10 and also the accumulating space 40 arranged in the pressure tank 50 to be cleaned at periodic intervals, the pressure tank 50 also has arranged in it at least one spray nozzle 90, via which a cleaning fluid can be introduced into the pressure tank 50. The filter 10 and also the interior of the pressure tank 50 can be cleaned by virtue of the filter 10 and also the interior of the pressure tank 50 and, in particular, of the accumulating space 40 being sprayed with a cleaning fluid and/or compressed air.

It has also been conventional practice to use hop pellets which have been pre-dissolved and have settled on the base of a container. However, this gave rise to large amounts of beer being lost in the waste which was separated off. The beer cleaning apparatus according to the invention, however, can significantly increase the output or the yield of cleaned beer. It is also possible in particular for cold-hopped beer to be cleaned to an exceptional extent. In the initial phase, the slide 60, the removal-line valve 56a, the outlet valve 66a and the feed valve 64a are preferably closed, whereas the return valve 62a and the bypass valve 68a are opened, in order for the liquid accumulated in the accumulating space 40 to be routed back to the feed line 54 via the return line 62 and the bypass 68.

In contrast, during normal operation, the return valve 62a and the bypass valve 68a are closed, whereas the feed valve 64a, the removal-line valve 56a and the outlet valve 66a are opened, in order for beer which is to be cleaned and is delivered from the feed pump 72 to be delivered to the exit 66 for cleaned beer via the filter 10 and the collecting space 20, by means of the removal-line pump 74. The slide 60 here is opened periodically or continuously in order for separated-off solids to be removed from the accumulating space 40.

Although, in the exemplary embodiment shown, the filter 10 has an essentially planar, obliquely positioned plate, it is also possible for the filter 10 to be in curved or undulating form. All that is necessary is for the filter to be inclined in relation to the horizontal, so that solids contained in the beer which is to be cleaned can slide downwards along the surface of the filter 10 without blocking up the openings of the filter 10. The inclination of the filter here is approximately 10 to approximately 80 degrees in relation to the horizontal, preferably approximately 30 to approximately 60 degrees in relation to the horizontal.

The method described is normally used in the temperature range of approximately 0° C. to approximately 25° C. It can also be used, however, in hot temperatures ranging from approximately 80° C. to approximately 110° C., preferably ranging from approximately 90° C. to approximately 100° C.

Although the feed pump 72 and the removal-line pump 74 are provided in the exemplary embodiment shown, it is also possible for the beer cleaning apparatus to be operated without electrically driven pumps, for example if a difference in height is used, where the infeed 64 is arranged at a higher level than the exit 66.

It is possible for the openings of the filter 10 to be in the manner of slits, in the form of slots, to be circular in shape or to be formed in any other configuration.

### LIST OF REFERENCE SIGNS

10 Filter
10a Underside of the filter
20 Collecting space
22 Outlet
24 Container base
26 Container wall
30 Overflow vessel
30a Inlet
30b Overflow
40 Accumulating space
50 Pressure tank
52 Pressure connection
54 Feed line
56 Removal line
56a Removal-line valve
58 Discharge point
60 Slide
62 Return line
62a Return valve
64 Infeed
64a Feed valve
66 Exit
66a Outlet valve
68 Bypass
68a Bypass valve
72 Feed pump
74 Removal-line pump
90 Spray nozzle

1. A method of cleaning or filtering beer, having the following steps:
applying beer onto an obliquely positioned filter, so that the beer runs down along the obliquely positioned filter and liquid contained therein passes through openings of the filter into a collecting space beneath the filter and solids contained in the beer slide downwards along the obliquely positioned filter, and
routing the filtered beer out of the collecting space.

2. The method according to claim 1, also comprising the following steps:
accumulating the solids in an accumulating space beneath the filter, and
periodically or continuously removing the solids from the accumulating space.

3. The method according to claim 1, wherein the step of applying the beer to the filter includes the step of arranging an overflow vessel in the upper region of the filter, in order to allow the beer which exits from the overflow vessel to flow onto the filter.

4. The method according to claim 1, wherein the beer is subjected to pressure by way of carbon dioxide during filtering.

5. The method according to claim 1, also having the step of periodically cleaning the filter by spraying the same with a cleaning fluid.

6. The method according to claim 1, wherein the filter is positioned obliquely through approximately 10° to approximately 80 in relation to the horizontal.

7. The method according to claim 1, wherein the filter is positioned obliquely through approximately 30° to approximately 60° in relation to the horizontal.

8. A beer cleaning apparatus having an obliquely positioned filter and a collecting space, which is arranged beneath the filter,
an overflow vessel with an inlet for the introduction of beer and with an overflow for applying the overflowing beer to the filter, and
an outlet, which is connected to the collecting space for the purpose of channeling away the cleaned beer.

9. The beer cleaning apparatus according to claim 8, also having an accumulating space beneath the filter for accumulating the solids separated off from the beer, wherein the accumulating space is preferably connected to a slide in order to open and close the accumulating space for the purpose of removing the solids.

10. The beer cleaning apparatus according to claim 8, wherein the filter is positioned obliquely through approximately 10° to approximately 80° in relation to the horizontal.

11. The beer cleaning apparatus according to claim 8, wherein the filter is positioned obliquely through approximately 30° to approximately 60° in relation to the horizontal.

12. The beer cleaning apparatus according to claim 8, also comprising a pressure tank, in which the filter and the collecting space are arranged and which can be connected to a gas source, in particular to a gas source containing carbon dioxide.

13. The beer cleaning apparatus according to claim 12, wherein the pressure tank also has at least one spray nozzle, which can be connected to a container provided with cleaning agent in order to clean the interior of the pressure tank and/or the filter.

14. The beer cleaning apparatus according claim 8, wherein a bypass with a bypass valve is arranged between the inlet of the overflow vessel and the outlet of the collecting space and/or a return line is arranged between a discharge point, which is connected to the accumulating space, and the outlet of the collecting space, the return line having a return valve in order for the return line to be opened or closed selectively.

15. The beer cleaning apparatus according to claim 8, wherein a respective pump, preferably an electrically driven pump, is arranged in an infeed to the inlet of the overflow vessel and/or in a removal line for channeling away cleaned beer from the outlet of the collecting space.

16. The beer cleaning apparatus according to claim 8, wherein the filter has slit-like openings with a slit width of approximately 100 to approximately 500 μm.

17. The beer cleaning apparatus according to claim 8, wherein the filter has slit-like openings with a slit width of approximately 200 to approximately 300 μm.
